(19) United States
(12) Patent Application Publication
(10) Pub. No.: US 2017/0170529 A1
(43) Pub. Date: Jun. 15, 2017

(54) BATTERY CELL, BATTERY MODULE AND METHOD FOR OPERATING THE SAME

(71) Applicant: Robert Bosch GmbH, Stuttgart (DE)

(72) Inventor: Helerson Kemmer, Vaihingen (DE)

(21) Appl. No.: 15/357,421

(22) Filed: Nov. 21, 2016

(30) Foreign Application Priority Data
Nov. 24, 2015 (DE) 102015223136.4

(51) Int. Cl. H01M 10/44; H01M 12/08

(52) U.S. Cl. CPC H01M 10/445; H01M 12/08; H01M 2220/20

(57) ABSTRACT

A battery cell includes a first and a second electrode, in particular a lithium-air battery cell, and a battery module is described having a feed for a gas mixture, in particular air, a first sensor device being provided for measuring a gas pressure and a second sensor device being provided for measuring an oxygen content in a gas mixture.

### RELATED APPLICATION INFORMATION

The present application claims priority to and the benefit of German patent application no. 10 2015 223 136.4, which was filed in Germany on Nov. 24, 2015, the disclosure of which is incorporated herein by reference.

### FIELD OF THE INVENTION

The present invention relates to a battery cell, a battery module, and a method for operating the same, as recited in the preamble of the independent patent claims.

### BACKGROUND INFORMATION

In hybrid, plug-in hybrid, and/or electric motor vehicles, batteries, or accumulators, are used to provide the necessary electrical energy to drive the vehicle. As batteries, in particular lithium-ion batteries are used that are made up of a plurality of battery cells connected to one another. Because these batteries, like other battery types, standardly can be optimally used only in a particular temperature range, the batteries used are standardly temperature-controlled using a thermal management system. For this, various cooling devices are used, such as cooling plates through which a coolant flows, to cool the battery or the battery cells of a battery. In particular to protect the battery and the associated battery components from environmental influences and mechanical stress, and to protect persons from electrical shock, these batteries are standardly housed in a housing that completely surrounds the battery. A housing can here in particular also be an installation compartment of the vehicle provided to accommodate the battery.

During the operation of a vehicle and the associated use of corresponding batteries, the problem arises that, in particular due to the cooling of the battery or of the battery cells, a local temperature can fall below the dew point temperature, i.e. the temperature at which the formation of condensate begins. When the dew point temperature is fallen below, humidity present in the air surrounding the battery can condense and be deposited on the cooled battery. Because in this way condensation water can also form on electrically conductive components, the danger exists that the condensation water will cause damage to the battery, for example because electrical contacts can be short-circuited by the condensation water.

In addition, so-called lithium-air accumulators, or lithium-air batteries, are currently the subject of development efforts worldwide, because lithium-air batteries can achieve higher energy density levels than can be achieved using lithium-ion technology.

In the mid-1990s, in U.S. Pat. No. 5,510,209 a lithium-air system of Abraham et al. was discussed which includes a polymer electrolyte layer situated between a negative electrode made of metallic lithium and a positive oxygen electrode.

Patent document US 2009/0053594 A1 discusses an air battery whose separator contains an organic solvent and that is based on an electrolyte that includes a lithium salt and an alkylene carbonate additive.

Patent document US 2010/0273066 A1 discusses a lithium-air battery that includes a non-aqueous electrolyte based on an organic solvent, the electrolyte including a lithium salt and an additive having an alkylene group.

Patent document US 2010/0291443 A1 discusses a cell that includes an oxygen cathode, an electrolyte that is made of stabilized zirconium oxide and conducts oxygen anions, an electrolyte made of a melted salt, and a lithium-based anode.

### SUMMARY OF THE INVENTION

The subject matter of the present invention is a battery cell, a battery module, and a method for operating the same, having the characterizing features described herein.

This is based on the fact that the battery cell according to the present invention, or the battery module according to the present invention, includes a feed for a gas mixture such as air or some other gas mixture, containing oxygen if warranted, as well as a first sensor device for determining a gas pressure and a second sensor device for determining an oxygen content of a gas mixture. According to the present invention, when the overall pressure of the gas mixture and its oxygen content are known, the content of gaseous contaminations, such as air humidity, can be inferred. If the battery cell according to the present invention is configured for example as a lithium-air battery cell, for its functioning it is then essential that the air supplied to the battery cell be largely free of air humidity and other gaseous components that damage the battery cell. In a battery module as well that includes an air supply, for example for cooling purposes, it is appropriate if the supplied air contains for example no air humidity, or largely no air humidity. This is because during operation at low temperatures, air humidity may result in the temperature falling below the dew point, thus resulting in condensation of water inside the battery module. This can be effectively counteracted by an effective monitoring of the air humidity content in the supplied cooling air.

Further advantageous specific embodiments are the subject matter of the further descriptions herein.

It is advantageous if the second sensor device is a sensor element that has a first electrode and a second electrode that are connected to one another via a solid electrolyte. This kind of sensor element is an electrochemical sensor element, in which, over a solid electrolyte that in particular conducts oxide ions, an electrochemical voltage is built up that is a function of the respective oxygen content of a gas mixture surrounding the sensor element, or in which, given a specified constant voltage between the first and second electrode, a corresponding pump current arises as a function of the oxygen content of the surrounding gas mixture. Such sensor elements are reliable, stable over the long term, and are adequately precise in their determination of the oxygen content even given the presence of a large quantity of gaseous substances of other types.

In addition, it is advantageous if, in addition to determining the oxygen content of a gas mixture, the second sensor device provided in the battery cell or in the battery module can also determine its water vapor content. In this way, in addition to a determination of the water vapor content on the basis of an absolute pressure of the gas mixture and its oxygen content, a second, independent path is provided for making it possible to directly determine the water vapor content of a gas mixture via a direct determination of the water vapor content and of the overall pressure of the gas mixture. This noticeably improves the measurement precision of the second sensor device.

According to a particularly advantageous specific embodiment of the present invention, the presence of gaseous impurities, or the presence of water vapor, in a gas mixture containing oxygen is inferred if the presence of such a gaseous impurity or of water vapor is ascertained through computation from the measured overall pressure of the oxygen-containing gas mixture and its oxygen portion.

Here, according to the present invention, the following is assumed:

The vapor molar flow rate \dot{n}ᵥₐₚₒᵣ of a gas mixture, here air, can be calculated from its partial pressure, the oxygen partial pressure, and the molar flow of oxygen according to:

$${\dot{n}}_{vapor} = {\dot{n}}_{{O}_{2}} \cdot \frac{{P}_{vapor}}{{P}_{{O}_{2}}} \qquad ( I )$$

Similarly, the following holds for the partial pressure of a gaseous contamination:

$${\dot{n}}_{contamination} = {\dot{n}}_{{O}_{2}} \cdot \frac{{P}_{contamination}}{{P}_{{O}_{2}}} \qquad ( II )$$

The overall air molar flow is:

$${\dot{n}}_{air} = {\dot{n}}_{{O}_{2}} \cdot \frac{{P}_{air}}{{P}_{{O}_{2}}} \qquad ( III )$$

The oxygen portion x₀_{₂} of dry, clean air is almost constant, and is approximately 0.21, so that the following holds:

$${\dot{n}}_{{O}_{2}} = {\dot{m}}_{{air}_{dry}} \cdot \frac{{x}_{{O}_{2}}}{{M}_{{air}_{dry}}} , \qquad ( IV )$$

where \dot{m}ₐᵢᵣ _{_{dry}} is the mass flow of dry air and Mₐᵢᵣ_{_{dry}} is the molar mass of dry air.

Likewise, the nitrogen portion x_{N}_{₂} is approximately 0.79, so that the following holds:

$${\dot{n}}_{{N}_{2}} = {\dot{m}}_{{air}_{dry}} \cdot \frac{{x}_{{N}_{2}}}{{M}_{{air}_{dry}}} \qquad ( V )$$

The combination of (IV) and (V) yields:

$${\dot{n}}_{{N}_{2}} = {\dot{n}}_{{O}_{2}} \cdot \frac{{x}_{{N}_{2}}}{{x}_{{O}_{2}}} \qquad ( VI )$$

The overall air molar flow is (further noble gases are added to the nitrogen molar flow for the sake of simplicity):

\dot{n}ₐᵢᵣ=\dot{n}_{O}_{₂}+\dot{n}_{N}_{₂}+\dot{n}_{contamination}+\dot{n}ᵥₐₚₒᵣ (VII)

Substituting (I) through (III) and (VI) in (VII) yields:

$$\dot{{p}_{contamination}} + {p}_{vapor} = {p}_{air} - {P}_{{O}_{2}} \cdot ( 1 + \frac{{x}_{{N}_{2}}}{{x}_{{O}_{2}}} ) \qquad ( VIII )$$

The second sensor device, for example in the form of a broadband lambda probe, supplies a current signal as a function of the oxygen partial pressure of the surrounding gas mixture in the form of air:

p_{O}_{₂}=f(I_{λ probe}). tm (IX)

Here the air pressure can be measured using a conventional pressure sensor as first sensor device.

Advantageously, the battery cell according to the present invention, the battery module according to the present invention, and the method according to the present invention for operating these can be used in lithium-ion batteries, lithium-sulfur batteries, or lithium-air batteries. These in turn are used in portable telecommunication systems, in mobile computers, in mobile applications such as electric vehicles, hybrid vehicles, or plug-in vehicles, as well as in electric bikes, or in stationary systems for storing electrical energy, for example for storing regeneratively recuperated electrical energy.

Advantageous specific embodiments of the present invention are shown in the drawing and are explained in more detail in the following description of the Figures.

### BRIEF DESCRIPTION OF THE DRAWINGS

FIG. 1 shows a schematic sectional representation of a battery cell according to the present invention in a first specific embodiment.

FIG. 2 shows a schematic representation of a battery module according to the present invention in a first specific embodiment.

FIG. 3 shows a schematic representation of a method according to the present invention for operating a battery cell according to FIG. 1, or for operating a battery module according to FIG. 2.

### DETAILED DESCRIPTION

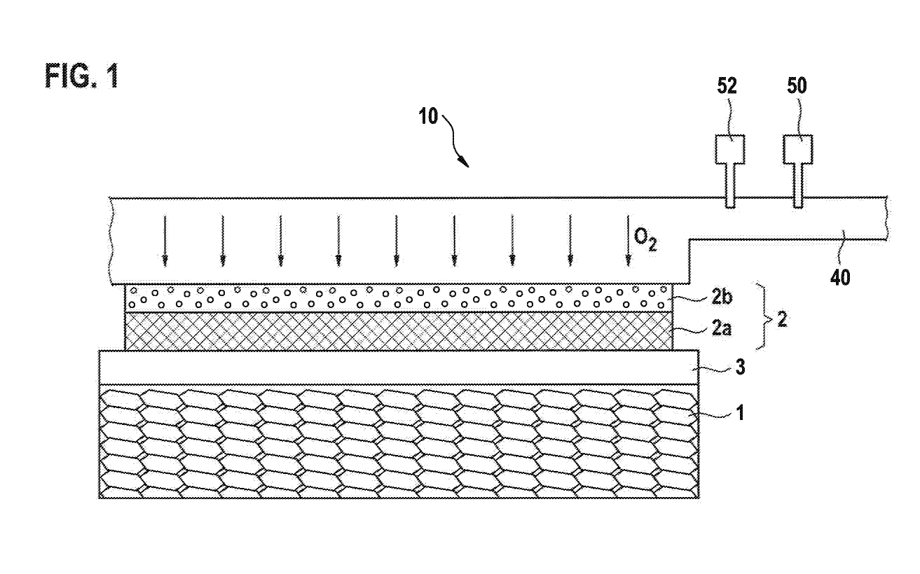

FIG. 1 shows a schematic sectional representation of a specific embodiment of a battery cell according to the present invention in the form of a lithium-air cell.

Lithium-air cell 10 includes a negative electrode 1, a positive electrode 2, and a separator 3.

Separator 3 is a lithium-ion-conducting inorganic solid electrolyte that is situated between negative electrode 1 and positive electrode 2 in such a way that at one side it directly adjoins negative electrode 1 and at the other side directly adjoins positive electrode 2.

Negative electrode 1 includes for example an intercalation material into which lithium can be reversibly intercalated and de-intercalated, i.e. put in place and removed. The intercalation material can in particular include at least one element from the fourth main group. For example, the intercalation material can be carbon, for example in the form of graphite, hard carbons, and/or soft carbons, or can be a material containing carbon and silicon, for example having 10 wt % to 99 wt % carbon and 1 wt % to 90 wt % silicon.

Positive electrode 2 is for example an oxygen electrode that may include a porous carbon matrix layer 2a adjoining separator 3, and a catalyst layer 2b, in particular a porous one, applied onto carbon matrix layer 2a. Carbon matrix layer 2a can for example include carbon black, conductive graphite, carbon nanotubes, or mixtures thereof.

FIG. 1 illustrates that oxygen, for example from atmospheric air, enters into lithium-air cell 10 via porous carbon matrix layer 2a, and is one of the active materials for the electrochemical reaction.

During the discharging of lithium-air cell 10, lithium ions can migrate from the intercalation material of negative electrode 1 through inorganic separator 3, which conducts lithium ions and contains solid electrolyte, in the direction of positive electrode 2, and can form lithium oxide there. The converse process takes place in the charging of lithium-air cell 10.

In addition, at an air feed 40 of lithium-air cell 10, a first sensor device is provided in the form of a pressure sensor 50, and a second sensor device is provided in the form of a so-called lambda probe 52, which includes an electrochemical determination of oxygen based on a first and second electrode that are connected to one another via an ion-conducting solid electrolyte.

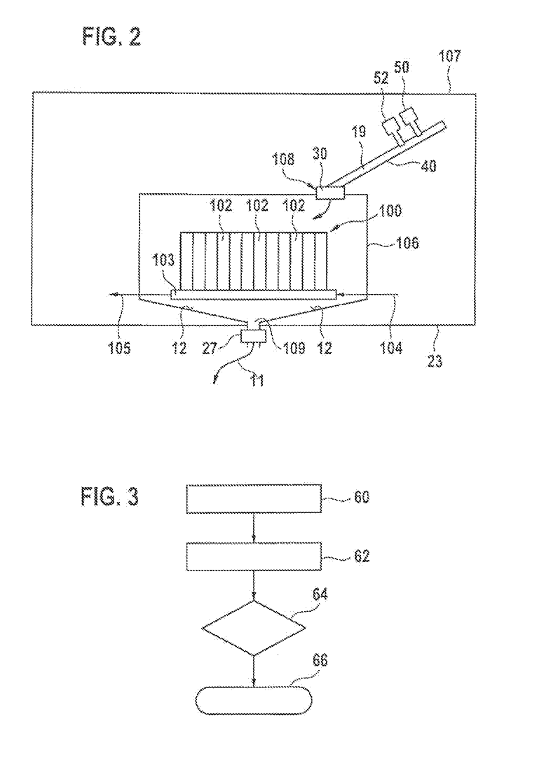

FIG. 2 shows a battery module, or battery, 100, in a housing 6. Battery 100 has a plurality of battery cells 102 that are wired to one another, and can for example be a lithium-ion battery. Battery 100 is cooled by a respective cooling device. The cooling device has a heat-conducting cooling plate 103 through which coolant flows, on which battery 100 is situated. Cooling plate 103 has a coolant inlet 104 via which a coolant is supplied, and a coolant outlet 105 via which the coolant is conducted away. Battery 100 according to the present invention is limited neither to the battery type shown in FIG. 2 nor to the design of the cooling device shown in FIG. 2.

Battery 100 is for example surrounded by a housing 106 that is situated in a passenger compartment 107 of an electric vehicle. Passenger compartment 107 is shown schematically in FIG. 2 by the rectangle designated 107. Housing 106 has for example an air entry opening 108 that is fashioned such that air can flow into housing 106 via air entry opening 108 in order to flow around battery 100.

In order to prevent gases from entering into passenger compartment 107 via air entry opening 108 when there is a release of gas by battery 100, in particular as a result of a so-called thermal runaway of one or more battery cells 102, a ball valve 30 is advantageously situated at air entry opening 108 as a device for preventing the exit of gases released by battery 100. When the internal pressure in housing 106 increases due to a release of gas, the ball of ball valve 30 moves against the force of gravity due to the pressure, and thus seals air entry opening 108.

In addition, housing 106 has an air outlet opening 109 that is fashioned so that air can flow out of housing 106. Except for air entry opening 108 and air outlet opening 109, housing 106 may be sealed essentially in airtight fashion, i.e. sealed in such a way that under normal operating conditions air cannot flow in or out through additional openings. Base surface 12 of housing 106 is made in the shape of a funnel in the present case, improving an outflow of the air through air outlet opening 109. In addition, liquid, such as condensation water, can flow out of housing 106 via inclined base surface 12.

As can be seen in FIG. 2, air inlet opening 108 and air outlet opening 109 are for example situated opposite one another. Air inlet opening 108 is situated such that air 19 can flow into housing 106 from passenger compartment 107.

In the exemplary embodiment shown in FIG. 2, the electric vehicle is for example equipped with a climate control system (not shown) such that before being supplied to passenger compartment 107 air is conducted along a vaporizer, whereby moisture is removed from air 19 by condensation drying.

Housing 106 and air outlet opening 109 are situated such that housing 106 is connected to the external air via air outlet opening 109. Air outlet 109 extends out from a vehicle floor 23 of passenger compartment 107.

To protect against penetrating liquids and/or solid material, air outlet opening 109 has for example a protective device 27. Using a sieve structure (not shown), solid materials such as stones or leaves can be prevented from entering. In particular in order to protect against splashing water, protective device 27 has in addition a ball valve (also not shown) that seals air outlet opening 109 when water presses against the ball valve.

During travel with the vehicle, there arises a pressure difference between the pressure in passenger compartment 107 and the pressure outside passenger compartment 107, whereby air flows from passenger compartment 107 into housing 106 via air inlet opening 108, as indicated by arrow 10. The inflowing air 10 here flows around battery 100, taking on moisture from housing 106, and flows out of housing 106 through air outlet opening 109. The air flowing out of housing 106 is shown by arrow 11. Through this targeted feeding of air 19 from passenger compartment 107 having a lower dew point temperature than the air in housing 106, water vapor is led out from housing 106, and condensation of water in housing 106, in particular on battery 100, is avoided.

In addition, at air supply 40 of battery 100 there is provided a first sensor device in the form of a pressure sensor 50, and a second sensor device in the form of a so-called lambda probe 52, which includes an electrochemical oxygen determination on the basis of a first and a second electrode that are connected to one another via an ion-conducting solid electrolyte.

FIG. 3 schematically shows an example of a method for operating a battery cell according to FIG. 1 or a battery module, or a battery, according to FIG. 2.

During running operation of battery cell 10 according to the present invention, or of a corresponding battery module or of a battery 100, in a first method step 60 the air pressure prevailing for example inside air feed 40, or the gas overall pressure prevailing there, is determined. In a second step 62, the oxygen portion, or oxygen partial pressure, of the oxygen-containing gas mixture supplied in air feed 40 is determined. This may take place using second sensor device 52, while the determination of the air pressure may take place using first sensor device 50. In a third method step 64 it is checked whether the oxygen-containing gas mixture contained in air feed 40, or the air supplied there, contains a portion of water vapor or some other gaseous impurity.

This is done using the following equation:

pₐᵢᵣ−p_{O2}(1+x_{N2}/x_{O2}) (1)

For the case in which a>0, as result 66 it is determined that the oxygen-containing gas mixture of air feed 40 contains water vapor or some other gaseous impurities. If a=0, then it is determined as result 66 that the oxygen-containing gas mixture in air feed 40 does not contain any observable portions of water vapor or other gaseous impurities.

On the basis of this calculation result, if observable portions of water vapor or gaseous impurities are present in the oxygen-containing gas mixture a corresponding regulation of air supply 40 can take place. This can take place for example by setting a value for a that is regarded as a threshold value, so that, given a counter value for a that is below the defined value and greater than 0, the presence of moisture or of a gaseous impurity in the gas mixture is inferred, but no measures are taken, and given values of a that are greater than the defined threshold value for a, measures are taken. These measures can for example be that air feed 40 is interrupted, or that air feed 40 is at least temporarily charged with another oxygen-containing gas mixture, for example a synthetic one, or with a stored oxygen-containing gas mixture that is free of water vapor. For battery cell 102, or battery 100, according to the present invention, this reduces the risk that components of the battery cell that are sensitive to water vapor will be irreversibly damaged. With regard to battery 100 according to the present invention, by avoiding water vapor in air supply 40 the risk is reduced that the feeding of water vapor into housing 106 of battery 100 may result in a condensing out of water at low operating temperatures, and thus possibly in corrosive damage to the corresponding battery cells 102 of battery 100.

1-13. (canceled)

14. A battery cell having a first electrode and a second electrode, comprising:
a feed for a gas mixture;
a first sensor device for measuring a gas pressure; and
a second sensor device for measuring an oxygen content in a gas mixture.

15. The battery cell of claim 14, wherein the second sensor device for acquiring an oxygen content of a gas mixture includes a sensor element having at least one first electrode and at least one second electrode, the first electrode and second electrode being connected to one another via at least one solid electrolyte.

16. The battery cell of claim 14, wherein at least one of the first sensor device and the second sensor device are positioned in the area of the feed for a gas mixture.

17. The battery cell of claim 14, wherein the second sensor device for determining the oxygen content of a gas mixture additionally determines the content of water vapor in a gas mixture.

18. A battery module, comprising:
a battery cell having a first electrode and a second electrode, including:
a feed for a gas mixture;
a first sensor device for determining a gas pressure; and
a second sensor device for determining an oxygen content in a gas mixture.

19. The battery module of claim 18, wherein the second sensor device for acquiring an oxygen content of a gas mixture includes a sensor element having at least one first and at least one second electrode, the first electrode and second electrode being connected to one another via at least one solid electrolyte.

20. The battery module of claim 18, wherein at least one the first sensor device and the second sensor device are positioned in the area of the feed for a gas mixture.

21. The battery module of claim 18, wherein the second sensor device for determining the oxygen content of a gas mixture additionally determines the content of water vapor in a gas mixture.

22. A method for operating a battery cell or a battery module, the method comprising:
determining an overall pressure of an oxygen-containing gas mixture supplied to the battery cell or to the battery module;
determining an oxygen content of the gas mixture; and
inferring, based on the measured overall pressure and the measured oxygen content of the oxygen-containing gas mixture, a presence of gaseous contaminations or the presence of water vapor in the oxygen-containing gas mixture.

23. The method of claim 22, wherein air is used as oxygen-containing gas mixture, and the presence of a gaseous contamination or the presence of water vapor in the oxygen-containing gas mixture is inferred if the measured overall pressure in the oxygen-containing gas mixture minus 4.76 times the oxygen content yields a value >0.

24. The method of claim 22, wherein the presence of a gaseous impurity in the oxygen-containing gas mixture, or the presence of water vapor in the oxygen-containing gas mixture, is inferred when the following holds:
pₐᵢᵣ−p_{O2}(1+x_{N2}/x_{O2})>a,
where pₐᵢᵣ is the overall pressure of the oxygen-containing gas mixture, p_{O2} is the oxygen content in the oxygen-containing gas mixture, x_{N2} is the molar nitrogen portion in the oxygen-containing gas mixture, and x₀₂ is the molar oxygen portion in the oxygen-containing gas mixture.

25. The battery cell of claim 14, wherein the battery cell is for use in one of a lithium-ion battery, a lithium-air battery, and a lithium-sulfur battery.

26. The battery cell of claim 14, wherein the battery cell is for use in one of an electric vehicle, a hybrid vehicle, and a device for storing regeneratively recuperated electrical energy.

27. The battery cell of claim 14, wherein the battery cell includes a lithium-air battery cell.

28. The battery cell of claim 14, wherein the the gas mixture includes air.

29. The battery module of claim 18, wherein the battery cell is for use in one of a lithium-ion battery, a lithium-air battery, and a lithium-sulfur battery.

30. The battery module of claim 18, wherein the battery cell is for use in one of an electric vehicle, a hybrid vehicle, and a device for storing regeneratively recuperated electrical energy.

31. The method of claim 22, wherein the battery cell or the battery module is for use in one of a lithium-ion battery, a lithium-air battery, and a lithium-sulfur battery.

32. The method of claim 22, wherein the battery cell or the battery module is for use in one of an electric vehicle, a hybrid vehicle, and a device for storing regeneratively recuperated electrical energy.
